(19) United States
(12) Patent Application Publication
(10) Pub. No.: US 2003/0229782 A1
(43) Pub. Date: Dec. 11, 2003

(54) Method for computer identification verification

(76) Inventors: Robert Bible JR., Rancho Santa Fe, CA (US); Mark Steven Burnett, La Jolla, CA (US)

Correspondence Address: NEIL K. NYDEGGER, NYDEGGER & ASSOCIATES, 348 Olive Street, San Diego, CA, 92103, US

(21) Appl. No.: 10/165,514

(22) Filed: Jun. 7, 2002

(51) Int. Cl. H04L 9/32

(52) U.S. Cl. 713/155; 713/202

(57) ABSTRACT

A method for verifying over a network that a user attempting to sign in and access an account (a sign-in user) is the same individual that originally set up the account (i.e. the setup user) includes the step of receiving machine specific information during account setup. The website then encrypts the received machine specific information and sends the encryption back to the setup user's computer for incorporation in the cookie file located on the computer's hard drive. When a user attempts to sign in to access the account, the website acquires the cookie file located on the sign-in user's computer and machine specific information about the sign-in user's computer. The cookie is decrypted to reveal the machine specific information acquired during setup, and this information is compared to the machine specific information acquired from the sign-in user's computer to generate a probability that the sign-in user is the setup user.

### FIELD OF THE INVENTION

The present invention pertains generally to methods for verifying the identity of a user on a computer network. More particularly, the present invention pertains to methods for verifying the identity of a buyer attempting to make a purchase at a website on the internet. The present invention is particularly, but not exclusively, useful for preventing an individual from stealing computer files from an authorized user and using the stolen files to pose as the authorized user and make an unauthorized purchase over the internet.

### BACKGROUND OF THE INVENTION

It is often important to verify the identity of an internet user. In particular, it is often critical to verify the identity of a buyer attempting to make a purchase on the internet. Further, identity verification is necessary and often required before allowing a customer access to banking and financial accounts. Another example where identity verification is desirable is an e-mail account which is made available only upon verification that the requesting user is in fact authorized to access the e-mail account. Other examples include the internet service providers and other membership organizations that must verify a user's identity and confirm the user's membership status before granting service access.

Typically, in order to access an account or make a purchase at a website, the user is prompted by a webpage to enter a user identification (such as the user's name or social security number) and a password. Usually, the password is initially established when the account is set up, and serves to prevent individuals who lack the password from accessing the account (i.e. unauthorized users). Unfortunately, the mere use of a password is often insufficient to thwart individuals who are intent on accessing another individual's account or making a transaction illegitimately. Passwords are often stolen, either from the owner's computer or from a document the owner has used to record the password. Additionally, users often choose passwords that are user specific and therefore easily predicted, such as the user's birthday, nickname or middle name. In short, passwords alone often provide insufficient protection, especially for security sensitive accounts such as financial records.

One way to decrease the misuse of passwords is to determine whether the machine (i.e. computer) being used to access the account is the same machine that was used to originally set up the account. Such a process attempts to confirm that the user is accessing his account using his own computer. The theory underlying this confirmation is that an unauthorized accessor will probably attempt to make a purchase or illegitimately access an account from another computer. Thus, if a user attempts to sign in and access an account (to make a purchase or other transaction) from a computer that was not used to set up the account, a security breach is assumed, and the website can require further assurances that the sign-in user is an authorized accessor. Unfortunately, internet users have resisted assigning unique machine serial numbers to each computer. Thus, the ability of a website to quickly verify a computer based on a serial number is generally unavailable.

One way to determine whether the machine (i.e. computer) being used to sign in and access an account is the same computer that was used to set up the account is to save an encrypted version of the user's password on the user's computer. Specifically, the encrypted version of the user's password can be stored in an identification cookie file on the user's computer during setup of the account. For the present disclosure, a cookie file is defined as any file or portion of a file that is stored on the user's computer and available to websites being accessed by the user. When the sign-in user subsequently attempts access to the account, the website can acquire the identification cookie file from the sign-in user's computer and decrypt the password from the identification cookie file to verify the user's identity. Unfortunately, even though the identification cookie files on most computers may be encrypted, they are still vulnerable to theft. Thus, an unauthorized user may be able to copy the identification cookie file from the computer that was used to set up the account, and use the copy of the identification cookie file on a different computer to pose as the account holder.

In light of the above, it is an object of the present invention to provide methods that are suitable for preventing an unauthorized individual from assuming the identity of an account holder and accessing the holder's account over the internet. It is another object of the present invention to provide methods for preventing an unauthorized user that has a stolen identification cookie file from an authorized account holder's computer from using the stolen identification cookie file to pose as the authorized account holder and make a purchase or access the holder's account. It is still another object of the present invention to provide a method for verifying the identity of sign-in users that minimizes the amount of user information that must be stored in a central database. It is yet another object of the present invention to provide a method for verifying a sign-in user's identity that generates a probability the sign-in user is authorized and uses that probability to decide whether to allow the sign-in user to perform a specific activity on the account. Yet another object of the present invention is to provide a method for computer identification verification which is easy to use, relatively simple to implement, and comparatively cost effective.

### SUMMARY OF THE PREFERRED EMBODIMENTS

The present invention is directed to a method for verifying over a network that a user attempting to sign in and access an account to make a purchase or transaction (hereinafter referred to as a sign-in user) is using the same computer that was used by the individual that originally set up the account (i.e. the setup user). In accordance with the present invention, the account can be established for any purpose and the method begins by receiving setup information from a setup user, typically at a website. For some applications, the setup information can include setup user information such as the user's name and a password. The setup information further includes machine specific information acquired from the computer that is utilized by the setup user to convey the setup information. For the present invention, the machine specific information (MSI) can include the computer name, the internet protocol (IP) address, the computer time and date offset from Greenwich Standard Time (GST), the network card ID, an alphabetical list of existing cookie files found on the computer, the number of existing cookie files stored on the computer, or any other information available to the website being accessed that is involatile or slowly changing, as well as the rates of change for this information. MSI can also include such non-machine oriented information as the frequency of use and the typical time-of-day for sign-in for a particular user on a particular machine.

Upon receipt of the setup information at the website, the received setup information is encrypted and the encrypted information is sent back to the computer of the setup user. Preferably, the encrypted information is sent to the computer for incorporation in an identification cookie file that is located on the computer's hard drive. Once the encrypted information is stored in an identification cookie file on the setup user's computer, the website awaits a return visit by the setup user. As discussed above, the purpose of the present invention is to distinguish between the unauthorized sign-in user that is posing as the original setup user and the original (i.e. authorized) setup user. Importantly, the present invention contemplates that the unauthorized sign-in user that is posing as the setup user may have copied the identification cookie file from the setup user's computer for use on the unauthorized user's computer.

During sign-in, the website optionally requires the sign-in user to submit sign-in user information such as the user's name and password. Further, during sign-in, the website receives the identification cookie file that is located on the hard drive of the computer being utilized to sign in. Additionally, the same type of machine specific information that was obtained during setup is acquired from the computer used to sign in.

Once received, the sign-in information is compared to the setup information by an algorithm at the website to predict whether the sign-in user is authorized to access the account. For this purpose, the identification cookie file from the computer that is utilized to sign in is first decrypted. Next, the decrypted information from the sign-in user is input into a comparison algorithm that has been established at the website. Specifically, the machine specific information about the sign-in user's computer, the decrypted identification cookie file from the sign-in user's computer and the name and password received from the sign-in user are input into the website's comparison algorithm.

For the present invention, the comparison algorithm is run to generate a probability that the sign-in user is the setup user. It is contemplated that the comparison algorithm may use fuzzy logic, neural networks or other artificial intelligence (Al) techniques to generate this probability. Further, the information received from all the setup users and sign-in users can be compiled in a database from which statistics can be extracted. This database can be used to observe the statistical variation in machine specific information from one sign-in event to another to dynamically tune the fuzzy logic coefficients in the comparison algorithm.

Once a probability that the sign-in user is the original setup user has been generated by the comparison algorithm, the probability can be used to decide whether to allow the sign-in user's request to perform a specific account activity. For example, a higher probability can be required by the website in order to allow a sign-in user to change an account than would be required to merely view an account status. Thus, for each specific account activity that is requested by a sign-in user, a minimum match probability can be established. Then, by comparing the minimum match probability to the probability generated by the comparison algorithm (i.e. the probability that the sign-in user is the setup user), the website can determine whether to allow the sign-in user to perform the specific account activity requested.

Additionally, each time a sign-in user is verified to be the setup user (or the probability that the sign-in user is the setup user exceeds a predetermined value), the website can update the identification cookie file on the sign-in user's computer. Specifically, the identification cookie file can be updated with an encryption of the new machine specific information received by the website during the sign-in. It is to be appreciated that the updated identification cookie file will provide more accurate information to the comparison algorithm during the next sign-in event. Furthermore, by updating the identification cookie file, the rate of change that occurs in the machine specific information elements (i.e. the computer time offset, the number of existing cookie files, etc.) becomes available for subsequent acquisition by the website for input into the comparison algorithm to verify identification.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a functional block diagram setting forth the sequential steps performed in accordance with the method of the present invention during the setup of an account;

FIG. 2 is a functional block diagram setting forth the sequential steps performed in accordance with the method of the present invention to determine whether to allow a sign-in user access to an account;

FIG. 3A is a schematic diagram showing the interaction between parties during setup and sign-in when the method of the present invention is used in a two party configuration;

FIG. 3B is a schematic diagram showing the interaction between parties during setup and sign-in for a multi-party configuration wherein sign-in is conducted at the account holder's site;

FIG. 3C is a schematic diagram showing the interaction between parties during setup and sign-in for a multi-party configuration wherein sign-in is conducted at the verification site; and

FIG. 3D is a schematic diagram showing the interaction between parties during setup and sign-in for a multi-party configuration wherein sign-in information is forwarded through the account holder's site for processing at the verification site.

### DESCRIPTION OF THE PREFERRED EMBODIMENT

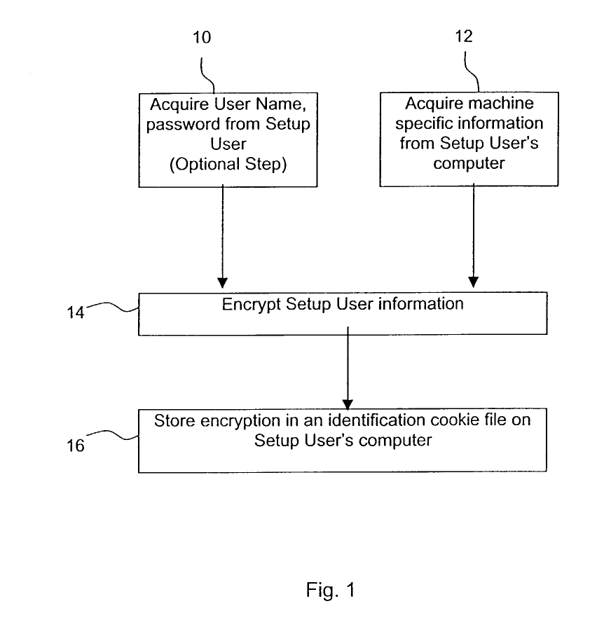

Referring initially to FIG. 1, a series of sequential steps to be performed during the setup of an account (i.e. a setup routine) in accordance with the method of the present invention is shown. For the present invention, the steps shown in FIG. 1 are performed to set up an account over a network, and allow later verification that a user attempting to sign in and access an account (hereinafter referred to as a sign-in user) is utilizing the same computer that was used by the individual that originally set up the account (i.e. the setup user). Specifically, it is contemplated by the present invention that the setup user will use a computer having a browser to access a website using the internet for the purpose of account setup. As shown in FIG. 1, for some applications, the method begins by receiving setup information from a setup user, typically at a website. As shown in optional block 10, for some applications the setup information can include the setup user information such as the user's name and a password. It is to be appreciated that the user's social security number or some other identifier can be used in place of or in conjunction with the user's name in block 10. The setup information further includes machine specific information (block 12) about the computer that is utilized by the setup user to convey the setup information. For the present invention, the machine specific information can include one or more of the following machine specific attributes: the computer name, the IP address, the computer time and date offset from GST, the network card ID, an alphabetical list of cookies found on the computer, the number of cookies stored on the computer, or any other information available to the website being accessed that is involatile or slowly changing, as well as the rates of change for this information. As mentioned above, MSI can also include such non-machine oriented information as the frequency of use and the typical time-of-day for sign-in for a particular user on a particular machine.

Next, as shown in block 14, the website encrypts the received setup information (i.e. blocks 10 and 12). For this purpose, any encryption technique known in the pertinent art, such as a computer encryption program, can be used to encrypt the setup information. Once encrypted, block 16 shows that the next step in the method of the present invention is for the website to send the encrypted information back to the setup user's computer. Specifically, as shown in block 16, the encrypted information is preferably sent to the setup user's computer for incorporation in an identification cookie file that is located on the computer's hard drive. As such, the setup information is permanently stored on the setup user's computer and the setup information is encrypted so that only a website with the appropriate decryption software can use or modify the stored setup information. Once the encrypted information is stored in the setup user's identification cookie file, the website awaits a return visit by the setup user.

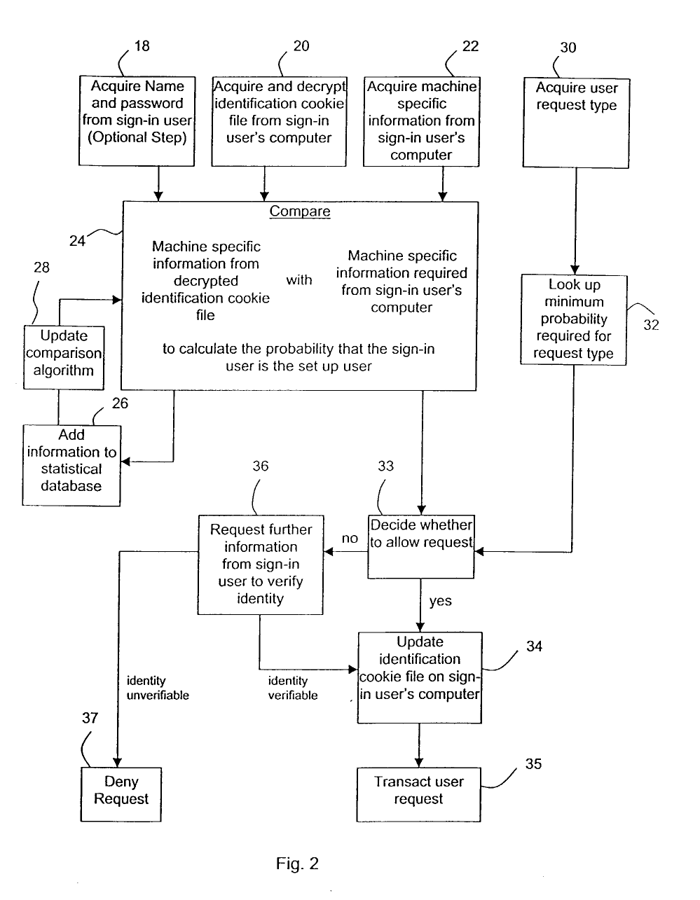

Referring now to FIG. 2, a functional block diagram setting forth the sequential steps to be performed in accordance with the method of the present invention to determine whether to allow a sign-in user access to an account (i.e. a sign-in routine) is shown. It is to be appreciated that the purpose of the present invention is to distinguish between the unauthorized sign-in user that is posing as the original setup user and the authorized sign-in user that is the original setup user. Further, the present invention contemplates that an unauthorized user may have copied the identification cookie file from the setup user's computer for use on his own computer before attempting to sign in and illegitimately access the account. As such, the present invention provides a method for distinguishing between the authorized account holder who is trying to access his account from the same computer that was used to set up the account, and the unauthorized user who has stolen the identification cookie file from the setup user's computer and is trying to use the stolen identification cookie file to sign in and access the account from a different computer.

Beginning with optional block 18 in FIG. 2, which may or may not be applicable, depending on the application, it is shown that during sign-in, the website requires the sign-in user to submit sign-in user information such as the user name and password. Further, as indicated by block 20, during sign-in the website acquires and decrypts the identification cookie file located on the hard drive of the computer being utilized to sign in. In applications where sign-in user information is not required, mere access of the website by the user will generally trigger the website to acquire the identification cookie file. It is to be appreciated that the acquired identification cookie file will generally contain the encrypted setup user's information if the sign-in user is using the same computer that was used during setup, or if the sign-in user has stolen the identification cookie file from the setup computer. If the acquired identification cookie file does not contain the encrypted setup user's information, access to the account will be denied unless further assurances by the sign-in user are forthcoming. If the acquired identification cookie file contains the encrypted setup user's information, then the method of the present invention is employed to distinguish between the sign-in user that is attempting access from the same computer that was used during account setup, and the sign-in user utilizing a different computer (i.e. the unauthorized sign-in user that has copied and transferred the identification cookie file from the setup computer to a new computer).

For this purpose, as indicated by block 20, the website also acquires machine specific information about the computer being utilized to sign in. Preferably, the website acquires that same type of machine specific information that was collected during setup. As indicated earlier, the machine specific information can include one or more of the following: the computer name, the IP address, the computer time and date offset from GST, the network card ID, an alphabetical list of cookies found on the computer, the number of cookies stored on the computer, or any other information available to the website being accessed that is involatile or slowly changing.

As shown in block 24, once received, the decrypted information from the acquired identification cookie file (i.e. block 20) is compared to the sign-in information (blocks 18 and 22) at the website to predict whether the same computer is being used to sign in that was used during setup. For this purpose, a comparison algorithm is established at the website and the information from the sign-in user (blocks 18, 20, and 22) is input into the comparison algorithm.

As shown in block 24, in accordance with the present invention, the comparison algorithm is run to generate a probability that the sign-in user is the setup user. Preferably, the comparison algorithm uses fuzzy logic, neural networks or other artificial intelligence (Al) techniques to generate the probability. For the present invention, any AI technique known in the pertinent art can be used. As further shown in FIG. 2, the information received from all of the sign-in users (blocks 18 and 22) and the data decrypted from all of the acquired identification cookie files (i.e. the setup information, block 20) can be compiled in a database (block 26). In accordance with the present invention, the data compiled in the database can be used to observe statistical variations in machine specific information among sign-in events to dynamically tune the fuzzy logic coefficients in the comparison algorithm (block 28).

Once the probability the sign-in user is the setup user is generated by the comparison algorithm (block 24), this probability can be used to decide whether to allow the sign-in user's request to perform a specific account activity. For example, a higher probability can be required by the website to allow a sign-in user to change an account than to merely view an account status, etc. It is to be appreciated that when the probability calculated in block 24 fails to exceed a predetermined threshold (e.g. 75%), no type of access to the account will be granted by the website unless other suitable forms of identification verification are provided by the sign-in user. For other cases, as indicated by block 30, the website can acquire a user request type from the sign-in user. Then, as indicated in block 32, the website can establish a minimum match probability for the specific account activity requested by a sign-in user. Next, as indicted by block 33, the website compares the minimum match probability (block 32) to the probability that the sign-in user is the setup user (block 24), to determine whether to allow the sign-in user to perform the specific account activity requested.

Once the sign-in user is verified (i.e. block 24) and the request is allowed (i.e. block 33), the website can be configured to update the identification cookie file on the sign-in user's computer (block 34) and the website can proceed to process the user's request (block 35). Specifically, the identification cookie file can be updated with an encryption of the new machine specific information received by the website during the sign-in. It is to be appreciated that the updated identification cookie file will provide more accurate information to the comparison algorithm during subsequent sign-in events. Furthermore, by updating the identification cookie file, the rate of change that occurs in the machine specific information elements (i.e. the computer time offset, the number of existing cookie files, etc.) becomes available for subsequent acquisition by the website for input into the comparison algorithm to verify identification.

In the event that the minimum match probability (block 32) exceeds the probability that the sign-in user is the setup user (block 24), the request will not be allowed (at block 33) based solely on the comparison algorithm. Rather, further information can be requested from the sign-in user (block 36). For example, direct communication between a human operator and the user can be established to obtain information leading to a positive verification. If this subsequent information is acceptable, the website can proceed to update the identification cookie (block 34) and then proceed to process the user's request (block 35). If this subsequent information is unacceptable, the user's request can be denied by the website (block 37).

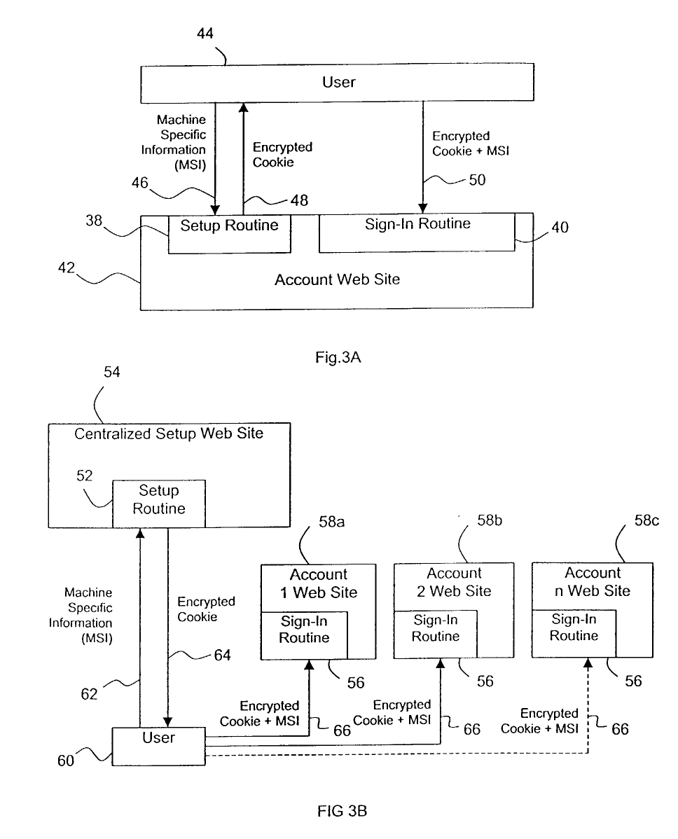

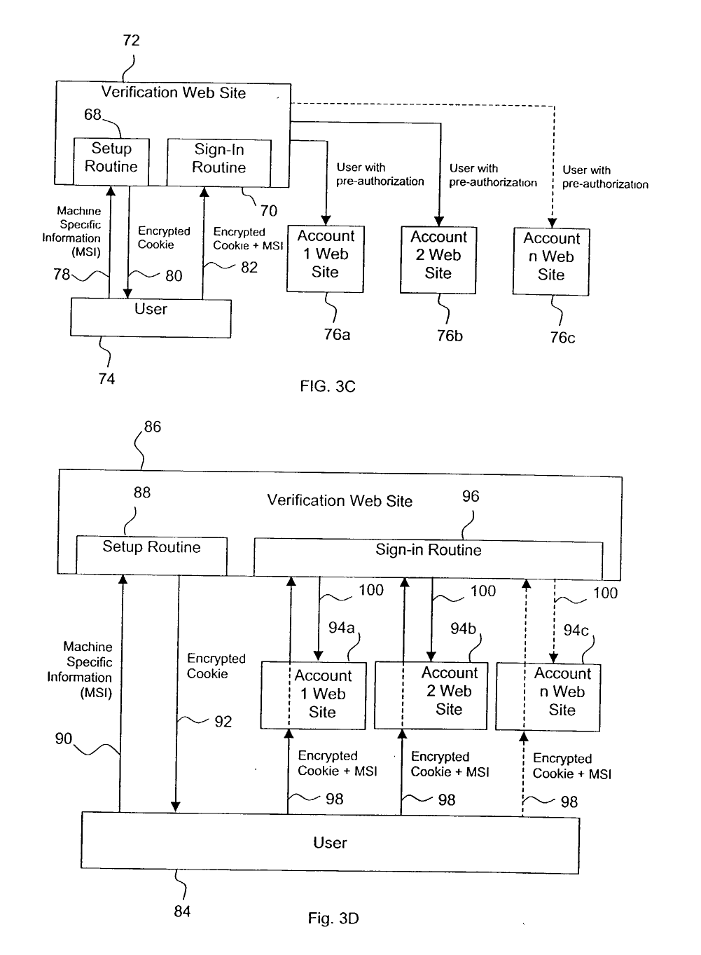

Referring now to FIGS. 3A-D, it can be seen that the method of the present invention can be implemented in a variety of ways, including two-party schemes and schemes involving three or more parties. As shown in FIG. 3A, a two party transaction can be configured wherein both the setup routine 38 and the sign-in routine 40 are performed at the same account website 42. Specifically, for this configuration, the user 44 connects via the internet with the account site 42 and subsequently sets up an account. As shown, during the setup routine 38, the account website 42 acquires machine specific information 46 (MSI) from the user 44 and saves an encrypted identification cookie file 48 on the user's computer. Later, at a subsequent session, the user 44 accesses the account site 42, again via the internet, and signs in to access the account. As shown, during the sign-in routine 40, the account website 42 acquires the encrypted identification cookie file and MSI 50. With this information, the account website 42 determines whether the user 44 can be granted access to the account.

Referring now to FIG. 3B, a multiple party configuration for the present invention is shown wherein the setup routine 52 is conducted at a setup website 54, and subsequently, the sign-in routine 56 can be performed at any of a number of account sites 58a-c. Specifically, for this configuration, the user 60 connects via the internet with a setup website 54 and subsequently sets up an account. For the present invention, the centralized setup website 54 could also function as a depository enabling monetary transactions in e-commerce. As shown, during the setup routine 52, the setup website 54 acquires machine specific information 62 (MSI) from the user 60 and saves an encrypted identification cookie file 64 on the user's computer. Later, at a subsequent session, the user 60 accesses one of the account sites 58, again via the internet, and signs in to access an account. In this configuration, the account sites 58 could be a seller's site where a product is sold or some other type of site where the user 60 has an account. In either case, once the setup routine 52 has been conducted at the central setup website 54, the user 60 can subsequently access one of the account sites 58, equipped to directly proceed with the sign-in routine 56. As shown, during the sign-in routine 56, the account website 58 acquires the encrypted identification cookie file and MSI 66. With this information, the account website 58 determines whether the user 60 can be granted access to the requested account.

Referring now to FIG. 3C, a multiple party configuration for the present invention is shown wherein the setup routine 68 and the sign-in routine 70 can be performed at a verification website 72 to thereby pre-authorize a user 74 for account access at one or more account sites 76a-c. Specifically, for this configuration, the user 74 connects via the internet with a verification website 72 and subsequently sets up an account. As shown, during the setup routine 68, the verification website 72 acquires machine specific information 78 (MSI) from the user 74 and saves an encrypted identification cookie file 80 on the user's computer. Later, at a subsequent session, the user 74 again accesses the verification website 72, again via the internet, and signs in to obtain pre-authorization for subsequent account access at one or more account sites 76a-c. As shown, during the sign-in routine 70, the verification website 72 acquires the encrypted identification cookie file and MSI 82. With this information, the verification website 72 determines whether the user 74 can be granted a pre-authorization status for subsequent account access at other affiliated account websites 76a-c. One application of the configuration shown in FIG. 3C is to provide a mechanism for low-cost monetary transactions in e-commerce. In this application, the verification website 72 functions as a depository and the account websites 76a-c can each be a seller's site where a product is sold. Upon sign-in and identity verification at the depository, access to a deposit account held at the depository can be granted, enabling the user 74 to proceed to affiliated seller sites and make purchases, charging the cost of the purchase to the deposit account.

Referring now to FIG. 3D, another possible configuration for the method of the present invention is shown. As shown, for this configuration, the user 84 connects via the internet with a verification website 86 and sets up an account. As shown, during the setup routine 88, the verification website 86 acquires machine specific information 90 (MSI) from the user 84 and saves an encrypted identification cookie file 92 on the user's computer. Later, at a subsequent session, the user 84 accesses one of the account websites 94a-c, again via the internet, for sign-in. As shown, the sign-in routine 96 actually occurs at the verification website 86. During sign-in, the account website 94 forwards the encrypted identification cookie file and MSI 98 to the verification website 86. With this information, the verification website 86 verifies the identity of the user 84 and forwards the verification identification information 100 back to the account websites 94a-c. With the verification identification information 100, the account websites 94a-c can allow the user 84 access to the requested account.

While the particular methods for computer identification verification as herein shown and disclosed in detail are fully capable of obtaining the objects and providing the advantages herein before stated, it is to be understood that they are merely illustrative of the presently preferred embodiments of the invention and that no limitations are intended to the details of construction or design herein shown other than as described in the appended claims.

What is claimed is:

1. A method for verifying that a sign-in user computer is the same computer originally used to set up an account at a network website, said method comprising the steps of:
obtaining setup information from a setup user, said setup information including machine specific information about the computer being utilized by the setup user to convey said setup information;
encrypting said setup information and storing said encrypted information in a cookie file on said computer being utilized by the setup user to convey said setup information;
receiving sign-in information from the sign-in user, said sign-in information including machine specific information about the computer being utilized by the sign-in user to sign in, and the cookie file from the computer being utilized by the sign-in user to convey said sign-in information;
decrypting said cookie file from the computer being utilized by the sign-in user to convey said sign-in information to obtain decrypted setup information; and
comparing said decrypted setup information to said sign-in information to predict whether said sign-in user computer is the same computer originally used to set up the account.

2. A method as recited in claim 1 wherein said setup information includes the setup user's name and a setup user's password.

3. A method as recited in claim 1 wherein said machine specific information about the computer being utilized by the setup user to convey said setup information comprises the computer name.

4. A method as recited in claim 1 wherein said machine specific information about the computer being utilized by the setup user to convey said setup information comprises the IP address.

5. A method as recited in claim 1 wherein said machine specific information about the computer being utilized by the setup user to convey said setup information comprises the computer time and date offset from GST.

6. A method as recited in claim 1 wherein said machine specific information about the computer being utilized by the setup user to convey said setup information comprises the network card ID.

7. A method as recited in claim 1 wherein said machine specific information about the computer being utilized by the setup user to convey said setup information comprises an alphabetical list of cookies found on the computer being utilized by the setup user to convey said setup information.

8. A method as recited in claim 1 wherein said machine specific information about the computer being utilized by the setup user to convey said setup information comprises the number of cookies stored on the computer being utilized by the setup user to convey said setup information.

9. A method as recited in claim 1 wherein said step of comparing said setup information to said sign-in information to predict whether said sign-in user computer is the same computer originally used to set up the account utilizes fuzzy logic routines.

10. A method for verifying that a sign-in user computer is the same computer originally used to set up an account at a network website, comprising the steps of:
maintaining a cookie file on the setup user's computer, said cookie file including machine specific information about the setup user's computer;
receiving sign-in information from the sign-in user, said sign-in information including machine specific information about the computer being utilized by the sign-in user to sign in, and the cookie file from the computer being utilized by the sign-in user to convey said sign-in information; and
comparing said setup information to said sign-in information to predict whether said sign-in user computer is the same computer originally used to set up the account.

11. A method as recited in claim 10 wherein the step of maintaining a cookie file on the setup user's computer includes the steps of:
receiving setup information from the setup user, said setup information including machine specific information about the computer being utilized by the setup user to convey said setup information;
encrypting said setup information and storing said encrypted information in a cookie file on said computer being utilized by the setup user to convey said setup information; and
updating the cookie file in response to information received during sign-in events wherein the sign-in user computer has been verified to be the same computer originally used to set up the account.

12. A method as recited in claim 10 wherein said machine specific information about the computer being utilized by the setup user to convey said setup information comprises the computer time and date offset from GST, as well as changes in machine specific information and the rates of these changes.

13. A method for verifying that a sign-in user computer is the same computer originally used to set up an account, said method comprising the steps of:
storing machine specific information about the computer being utilized by the setup user to convey setup information in the cookie file at the setup user's computer;
establishing a comparison algorithm;
inputting machine specific information about the computer being utilized by the sign-in user into said comparison algorithm;
inputting information from the cookie file stored on the computer being utilized by the sign-in user into said comparison algorithm; and
running said comparison algorithm to generate a probability that the sign-in user computer is the same computer originally used to set up the account.

14. A method as recited in claim 13 wherein said comparison algorithm uses fuzzy logic techniques.

15. A method as recited in claim 13 further comprising the steps of:
storing information received from a plurality of setup users and a plurality of sign-in users in a database; and
using said database to update said comparison algorithm.

16. A method as recited in claim 13 further comprising the steps of:
receiving from said sign-in user a request to perform a specific account activity;
generating a minimum match probability for said specific account activity; and
comparing said minimum match probability to said probability that the sign-in user computer is the same computer originally used to set up the account to determine whether to allow said sign-in user to perform said specific account activity.

17. A method as recited in claim 13 wherein said machine specific information about the computer being utilized by the setup user to convey said setup information comprises the computer time and date offset from GST.

18. A method as recited in claim 13 wherein the step of storing machine specific information about the computer being utilized by the setup user to convey setup information in the cookie file at the setup user's computer comprises the step of encrypting said machine specific information about the setup user's computer.

19. A method as recited in claim 16 wherein said receiving step is performed at a first website and said comparing step is performed at a second website.

20. A method as recited in claim 16 wherein said receiving step and said comparing step are performed at the same website.
